(19) United States
(12) Patent Application Publication
(10) Pub. No.: US 2006/0087397 A1
(43) Pub. Date: Apr. 27, 2006

(54) Fuse state indicating optical circuit and system

(75) Inventors: Michael Craig Henricks, Ballwin, MO (US); Henry Saul Feldstein, Chesterfield, MO (US)

Correspondence Address: John S. Beulick;Armstrong Teasdale LLP, One Metropolitan Square, St. Louis, MO, 63102, US

(73) Assignee: Cooper Technologies Company

(21) Appl. No.: 10/973,628

(22) Filed: Oct. 26, 2004

(51) Int. Cl. H01H 85/30

(52) U.S. Cl. 337/265

(57) ABSTRACT

A fuse state indicating system includes at least one fuse comprising a primary fuse element, and an indicating circuit proximate the fuse and disassociated from the primary fuse element. The indicating circuit is configured to detect an opening of the primary fuse element wherein a circuit path is broken through the primary fuse element. The circuit is further configured to transmit an optic signal to a remote location when the opening of the primary fuse element is detected, and the signal is transmitted without mechanical actuation of the circuit.

### CROSS REFERENCE TO RELATED APPLICATIONS

The subject matter of this application is related to commonly owned U.S. application Ser. No. 09/537,518 filed Mar. 29, 2003, now issued U.S. Pat. No. 6,556,996, commonly owned U.S. application Ser. No. 10/823,905 filed Apr. 14, 2004, and commonly owned U.S. application Ser. No. 10/936,406 filed Sep. 8, 2004, the disclosures of which are hereby incorporated by reference in their entirety.

### BACKGROUND OF THE INVENTION

This invention relates generally to fuses and, more particularly, to fuses with a fuse state indicator.

Fuses are widely used as overcurrent protection devices to prevent costly damage to electrical circuits. Fuse terminal elements (e.g., end caps or terminal blades) typically form an electrical connection between an electrical power source and an electrical component or a combination of components arranged in an electrical circuit. A fusible link or fusible element is connected between the fuse terminal elements, so that when electrical current flowing through the fuse exceeds a predetermined limit, the fusible link or element melts and opens the circuit through the fuse to prevent electrical component damage.

Certain fuses include local fuse state indicators which facilitate identification of opened fuses for replacement, and it is sometimes desirable to additionally provide remote fuse state indication features in certain operating systems. Thus, when the fusible element or link in the fuse opens, a signal can be sent to a remote location, such as an operator station, which may be used alert maintenance personnel or other interested persons of an opened fuse in the electrical system so that the fuse may be replaced and the electrical system re-energized. In the approximate location or vicinity of the opened fuse, local fuse state indicators visually identify the opened fuse for replacement. Conventionally, in systems of this type a mechanical pin or mechanical actuation element extends from the housing of the fuse for local fuse state identification purposes, and the mechanical actuation element contacts and activates a microswitch for communicating a signal to a remote location. Typically, this entails a hard-wire mechanical attachment to the fuse or microswitch for such purposes. Such hard-wired connections, however, can increase the cost and complexity of the fused electrical system, and mechanically actuated local fuse state indicators can present reliability issues in use.

U.S. Pat. No. 6,566,996 to Douglass et al., is directed toward a combustible fuse state indicator which is notable both for its low cost construction and its reliability in comparison to other types of local fuse state indicators. The combustible fuse state indicator of the '996 patent includes a combustible substance located adjacent a transparent lens extending through a side of a rectangularly shaped fuse module. A secondary fuse link extends adjacent the combustible substance and heat associated with opening of the secondary fuse link ignites the combustible substance to reveal a backing layer of a contrasting color. The combustible fuse state indicator is adaptable to other types of fuses, including cylindrical or cartridge fuses, as described in copending and commonly owned U.S. application Ser. Nos. 10/823,905 and 10/936,406.

While such combustible indicators can reliably provide local fuse state indication, implementing remote fuse state indication features with such indicators is a challenge.

### BRIEF DESCRIPTION OF THE INVENTION

In an exemplary embodiment, a fuse state indicating system is provided. The system comprises at least one fuse comprising a primary fuse element, and an indicating circuit proximate the fuse and disassociated from the primary fuse element. The indicating circuit is configured to detect an opening of the primary fuse element wherein a circuit path is broken through the primary fuse element. The circuit is further configured to transmit an optic signal to a remote location when the opening of the primary fuse element is detected, and the signal is transmitted without mechanical actuation of the circuit.

According to another exemplary embodiment, a fuse indicating system is provided. The system comprises a fuse having a primary fuse element and a local fuse state indicator. The local fuse state indicator is responsive to an operating condition of the primary fuse element and visually indicates the operating condition of the primary fuse element without utilizing a mechanical indicating element. An indicating circuit is responsive to a state of the local fuse state indicator, and the indicating circuit is configured to send an optic signal to a remote location when the local fuse state indicator indicates that the primary fuse element is inoperable.

According to yet another embodiment, a fuse state indicating system is provided. The system comprises at least one fuse comprising a primary fuse element, and an optically activated indicating circuit is proximate the fuse and disassociated from the primary fuse element. The circuit comprises a light detecting element configured to detect an opening of the primary fuse element and a light emitting element configured to transmit an optic signal to a remote location.

According to still another embodiment, a fuse state indication system comprises a fuse having a primary fuse element and a combustible fuse state indicator for local fuse state indication; means for detecting combustion of the combustible fuse state indicator; and means for transmitting a signal to a remote location, responsive to the means for detecting, when the combustion occurs.

### BRIEF DESCRIPTION OF THE DRAWINGS

FIG. 1 is a top plan view of a known fuse including a local fuse state indicator.

FIG. 2 is another plan view partly broken away of the fuse shown in FIG. 1.

FIG. 3 is an exploded bottom perspective view of the fuse state indicator assembly for the fuse shown in FIGS. 1 and 2.

FIG. 4 is an exploded assembly view of the fuse shown in FIGS. 1 and 2.

FIG. 5 is top plan view of an exemplary panel for the fuse shown in FIGS. 1-4.

FIG. 6 is a schematic block diagram of a fuse indicating system including the panel shown in FIG. 5.

FIG. 7 is an exemplary circuit schematic for the system shown in FIG. 6.

### DETAILED DESCRIPTION OF THE INVENTION

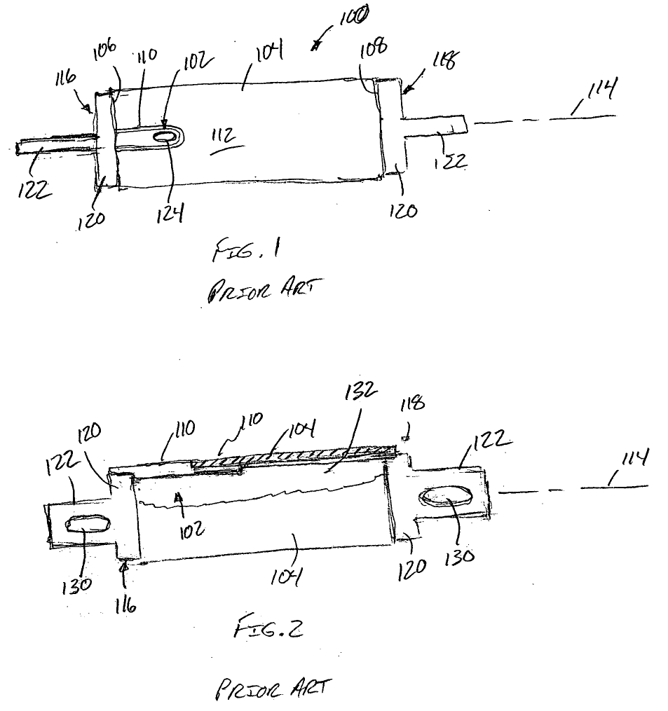

FIG. 1 is a top plan view of an exemplary fuse 100 including a local fuse state indicator assembly 102 which may be used in conjunction with a remote fuse state indication system, explained below. As will become apparent below, remote fuse state indication may be provided without hard-wired connections to the fuse 100 and without mechanical actuating elements.

The fuse 100 includes a cylindrical fuse tube or body 104 fabricated from an insulative (i.e., nonconductive) material and having a first end 106, a second end 108 and a bore (not shown in FIG. 1) extending therebetween which houses a primary fuse element assembly (not shown in FIG. 1). An elongated slot 110 is formed in the body 104, and a portion of the indicator assembly 102 is located in the slot 110 on an outer surface 112 of the body 104. In one embodiment, the slot 110 extends from the first end 106 of the body 104 toward the second end 108 for a predetermined distance, and the slot 110 extends in a direction generally parallel to a longitudinal axis 114 of the fuse 100.

Conductive terminal elements 116 and 118 are attached to the fuse body 104 on each end 106 and 108 of the body 104. In an exemplary embodiment, the terminal elements 116 and 118 are each an end bell assembly including a base 120 which is received in the ends 106, 108 of the body 104, and blades 122, sometimes referred to as knife blades, extending outwardly from the base 120. The terminal elements 116 and 118 may be connected to line side and load side electrical circuitry (not shown in FIG. 1), thereby forming a current path through the primary fuse element assembly. In accordance with known fuses, the primary fuse element assembly may include one or more fusible links or fuse elements extending through the fuse body 104 between the terminal elements 116 and 118.

A portion of the local fuse state indicator assembly 102 is situated in the slot 110 in the body 104 proximate the first end 106 and the terminal element 116. The portion of the fuse state indicator 102 is visible through the slot 110 in the body 104 to indicate an operating condition or state of the fuse 100 via an indicator window 124. The local fuse state indictor assembly 102 is electrically connected to the terminal elements 116 and 118 in the manner explained below, and visually indicates the operating state or condition of the primary fuse element assembly without mechanically actuated indicator elements. More specifically, the window 124 indicates, in the manner explained below, whether the primary fuse element assembly is in an unopened or operative state wherein current is conducted through the primary fuse element assembly, or whether the primary fuse element assembly is an opened or inoperative state wherein the circuit through the fuse element is broken. Thus, by visual observation of the window 124, inoperative or opened fuses may be rather quickly and easily identified for replacement.

It is understood that the fuse 100 is but one example of a fuse in which the indicator assembly 102 may be utilized. While in the exemplary embodiment the fuse body 104 is elongated and generally cylindrical, it is appreciated that the benefits of the indicator assembly 102 may apply to fuses having non-cylindrical bodies, such as rectangular fuse bodies and the like as those in the art will appreciate. Commonly owned U.S. Pat. No. 6,556,996 and commonly owned U.S. application Ser. No. 10/832,905 which are incorporated by reference herein each describe, for example, other types, configurations, and adaptations of fuses having a local fuse state indicator similar to the assembly 102.

Likewise, while the illustrated fuse includes end bell terminal elements 116, and 118, the indicator assembly 102 has equal applicability to other types of terminal elements known in the art for connecting line side and load side circuitry to the fuse. It is therefore understood that the indicator assembly 102 is applicable to a wide variety of fuses intended for a wide variety of applications and having a wide variety of fuse ratings, and accordingly the fuse embodiments shown and described herein and the particular embodiment of the local fuse state indicator assembly 102 are set forth for illustrative purposes only. The invention is not intended to be limited to a particular fuse shape, type, class or rating, or to a specific embodiment of a local fuse state indicator.

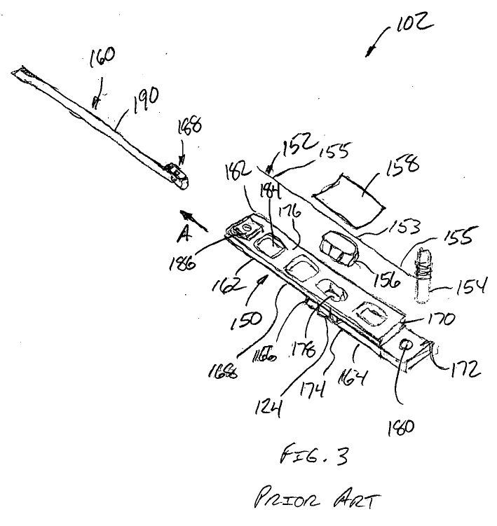

FIG. 2 illustrates the exemplary fuse 100 rotated 90° about the longitudinal axis 114 from the position shown in FIG. 1. The terminal elements 116 and 118 extend from each respective end 106, 108 of the fuse body 104, and the blades 122 extend in a substantially rectangular configuration on each end of the body 104. In accordance with known blade fuses, apertures 130 are provided in the blades 122, although in alternative embodiments the apertures may be omitted as desired or as needed to obtain specified fuse performance and installation parameters.

As illustrated in FIG. 2, the local fuse state indicator assembly 102 rests upon the base 120 of the first terminal element at a first end of the indicator assembly 102, extends within the slot 110 in the housing 104 and is substantially flush with the outer surface 110 of the fuse body 104, and extends interior to the fuse body 104 within an opening or bore formed in the body 104. As such, the fuse state indicator assembly 102 is partly exposed from the fuse body 104, and partly protected by the fuse body 104.

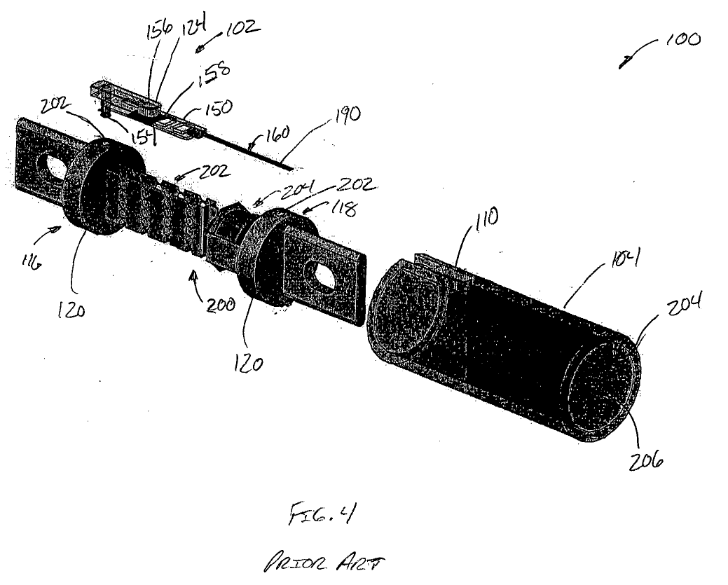

FIG. 3 is an exploded bottom perspective of an exemplary fuse state indicator assembly 102 for use with, for example, the fuse 100 (shown in FIGS. 1 and 2). In an illustrative embodiment, the fuse state indicator assembly 102 includes an insulative (i.e., nonconductive) extension member 150, a secondary fuse link 152, a contact pin 154, an indicator element 156, a backing layer 158 and a conductive clip 160.

The extension member 150 includes a clip portion 162 and an overlapping raised portion 164 extending from the clip portion 162. The raised portion 164 includes an end wall 166 which extends substantially perpendicularly to on outer surface 168 of the clip portion 162, and the clip portion 162 includes an end wall 170 which extends substantially perpendicularly to an inner surface 172 of the raised portion 164. As such, the outer surface 168 of the clip portion 162 is recessed relative to an outer surface 174 of the raised portion 164, and the inner surface 172 of the raised portion 164 is recessed relative to an inner surface 176 of the clip portion 162. In use, the raised portion 164 of the extension member 150 is received in the slot 110 (shown in FIGS. 1 and 2) of the fuse body 104 and the outer surface 168 of the clip portion 162 lies adjacent an interior surface of the fuse body (see FIG. 2), while the inner surface 172 of the raised portion 164 is positioned over the terminal element 116 (see FIG. 2), and the end walls 166, 172 function as stop surfaces to locate the extension member 150 with respect to the slot 110 and the terminal element 116, respectively. The raised portion 164 may include crush ribs on the side surfaces thereof which anchor the raised portion 164 to corresponding side surfaces of the slot 110 (FIG. 1) via an interference fit.

In an exemplary embodiment, the extension member 150 is generally bowed or curved in each of the clip and raised portions 162 and 164. The outer surface 168 of the clip portion 162 has a radius of curvature which is substantially equal to the radius of curvature of an inner surface of the fuse body 104, and the outer surface 174 of the raised portion 164 has a radius of curvature which is substantially equal to the radius of curvature of the outer surface 112 (FIG. 1) of the fuse body 104. The extension member 150 is elongated in a longitudinal direction parallel to the axis 114 (FIGS. 1 and 2) of the fuse 100, and the extension member 150 is curved in a lateral direction (i.e., a direction transverse to the axis 114) so that the extension member 150 generally conforms with and is complementary to the inner and outer surfaces of the fuse body 104 when the indicator assembly 102 is installed.

The extension member 150 further includes a recessed housing or cavity 178 extending from the inner surface 176 of the clip portion 162 toward the raised portion 164 and in a location adjacent the end wall 166 of the raised portion 164. The cavity 178 is sized and dimensioned to receive the indicator material 156 described below, and in one embodiment the cavity 178 includes the window 124 at a bottom thereof such that the window 124 is located adjacent the end of the slot 110 of the fuse body 104 as shown in FIG. 1. The window 124 is a transparent lens which may be fabricated from a transparent material known in the art, including, but not limited to, polycarbonate, polysulfone, polyethersulfone, and acrylic.

The extension member 150 also includes an aperture 180 formed in the inner surface 172 of the raised portion 164 which overhangs the clip portion 162, and the aperture 180 is accessible from the inner surface 172 to receive a portion of the contact pin 154. In one embodiment, the contact pin 154 is fabricated from a conductive material into a substantially cylindrical form, and the aperture 110 is cylindrical in shape and dimensioned to receive the contact pin 154 with an interference fit with the pin 154 extending outwardly from the surface 172 of the raised portion. It is recognized, however, that in alternative embodiments the pin 154 and the aperture 180 may be shaped otherwise without departing from the scope of the present invention.

A leading end 182 of the clip portion 162 includes a mounting aperture 184 and a mounting flange 186 which receive and attach, respectively, a hooked end 188 of the clip 160. The mounting flange 186, like the extension member 150, may be fabricated from a variety of materials known in the art, and in an exemplary embodiment, is fabricated from plastic.

In an exemplary embodiment, the indicator material 156 is a combustible substance in the form of a tuft of nitrocellulose cotton that is easily ignitable and substantially fills the recessed cavity 178 in the extension member 150. The indicator material 156 rests upon the backing layer 158 at a distance from the window 124. In an alternative embodiment, the indicator material 156 only partially fills the cylindrical housing 178, thereby creating an insulating air gap (not shown) between the window 124 and the indicator material 156 that both provides for combustion of the combustible substance and protects the window 124 from the associated heat when the secondary fuse link 152 ignites the indicator material 156. The indicator material 156 has a contrasting color relative to the backing layer 158, which may be any contrasting color relative to the indicator material 156 for ready indication of the fuse state, as described further below. In one embodiment, the indicator material 156 is white and the backing layer 158 is black.

In a further embodiment, a known energetic chemical compound may be used to assist ignition of the indicator material 156. One such energetic chemical compound is described in commonly owned. U.S. Pat. No. 6,556,996 which is incorporated by reference herein. It is contemplated, however, that other compounds may be employed in other embodiments to assist or facilitate ignition and combustion of the indicator material 156.

In alternative embodiments, other readily combustible materials known in the art may be used in lieu of nitrocellulose cotton as the indicator material 156. For example, pure nitrocellulose, combustible substances such as cellulose paper, polymer film, polymer felt, and cellulose felt may be used within the scope of the present invention. In such embodiments, the indicator material 156 is located adjacent and/or within the recessed cavity 178 in various forms, including but not limited to circular disks that are, for example, 0.001 inches to 0.010 inches thick. The disks may be dimensioned to be larger in dimension than the cavity 178 and/or the window 124 so that the indicator material 156 extends beyond the recessed cavity 178.

The secondary fuse link 152 is coupled to the extension member 162 and to the hooked end 188 of the clip 160 at one end, and is coupled to the contact pin 154 at an opposite end. The secondary fuse link 152 has a much higher electrical resistance than the primary fuse element assembly (not shown in FIG. 3) of the fuse so that, during normal operation of the fuse, substantially all of the current passing through the fuse passes through the primary fuse element assembly. The secondary fuse link 152, however, is fabricated to melt at a designated current in accordance with a desired amperage rating of the fuse.

In an exemplary embodiment, the secondary fuse link 152 is fabricated from a fine fuse wire, such as, for example, a thin wire fabricated from copper, a copper alloy, or chrome, having a predetermined resistance which forms a high resistance portion 153 in the fuse link 152 proximate the cavity 178 in the extension member 150. A second wire, which is different from fuse wire, is wrapped or twisted about the fine fuse wire on the ends thereof to form lower resistance portions 155 on either side of the high resistance portion. A central portion of the fuse wire (i.e., the high resistance portion 153) in the vicinity of the combustible substance 156, however, does not include the second wire twisted thereabout. In an illustrative embodiment, the second wire has a comparatively lower resistance than the fuse wire and is for example, wound about the fuse wire for a predetermined number of twists to form the lower resistance portions 155 in the secondary fuse link 153. The twisted wire on the fuse wire of the secondary fuse link 152 effectively creates lower resistance termination portions 155 which may be mechanically and electrically connected in parallel with the primary fuse element assembly through the clip 160 and the contact pin 154 as described below, while providing a high resistance portion 155 proximate the combustible substance 156. The high resistance portion 153 ensures reliable ignition and consumption of the combustible substance 156 in an overcurrent condition to reveal the contrasting backing layer 158 and identify the operative state of the fuse as described above. With strategic employment of high and low resistance portions in the secondary fuse link 152, a wide range of electrical resistance combinations may be achieved in the secondary fuse link 152 to obtain a wide range of amperage ratings for the associated fuse (e.g., 6 A to 600 A in one embodiment.

In an alternative embodiment, a secondary fuse link 152 having a high resistance portion 155 and lower resistance portions 155 may be fabricated from a high resistance fine fuse wire coated, plated or overlaid with, for example, copper or another suitable material having a lower resistance. A portion of the copper plating may be stripped, cut, or otherwise removed from the plated wire to form the high resistance portion 155. The remaining plated portions of the wire flanking the high resistance portion 153 form the lower resistance portions 355 for termination to the terminal elements 116 and 118 (FIGS. 1 and 2).

In other embodiments, secondary fuse link 152 may be fabricated from a single fuse wire of a material known in the art, including but not limited to copper, and copper alloys including zinc, nickel, chromium, tin, iron, molybdenum, aluminum, berylium, and silicon.

The backing layer 158 is disposed adjacent and extends beyond the indicator material 156 so as to be concealed or hidden from view by the indicator material 156 when viewed through the top of the window 124 as shown in FIG. 1. The backing layer 158 is of a contrasting color relative to the indicator material 156, and is generally coextensive with the indicator material 156. Disposed between the indicator material 156 and the backing layer 158 is the secondary fuse link 152.

In an exemplary embodiment, the backing layer 158 is flexible and includes an adhesive or tacky layer on one side thereof. The flexible backing layer 158 is applied to the inner surface 176 of the extension member 150 adjacent the secondary fuse link 152 and the indicator material 156, thereby keeping the indicator material 156 in place within the recessed cavity 178 and maintaining the position of the secondary fuse link 152 with respect to the extension member 150. The backing layer 158 is fabricated from a relatively noncombustible material relative to the indicator material 156, and is contrasting in color relative to the indicator material 156. In an illustrative embodiment, the backing layer 236 is fabricated from, for example, black vinyl insulating tape having a sharp color contrast with the indicator material 156, and the vinyl insulating tape secures the secondary fuse link 152 to the extension member 150 proximate the indicator material 156. The flexibility of the vinyl insulating tape accommodates the curvilinear shape of the extension member 150 while reliably positioning the secondary fuse link 152 in proper position relative to the indicator material 156 to ensure reliable ignition thereof upon the occurrence of a specified overcurrent condition. In further, and/or alternative embodiments, other insulative (i.e., nonconductive) materials, whether flexible or rigid, may be employed by adhesive or other attachment methods in lieu of vinyl insulating tape to accommodate the curved shape of the extension member 150.

The clip 160 is fabricated from a conductive material, and in the illustrative embodiment, is fabricated from strips or ribbons of conductive material, such as copper or copper alloys, including but not limited to alloys including zinc, nickel, chromium, tin, iron, molybdenum, aluminum, berylium, and silicon. The clip 160 is formed or folded to include the hooked end 188 extending from an elongated strip 190. The hooked end 188 is inserted through the mounting aperture 184 in the extension member 150 and moved in the direction of arrow A until the hooked end 188 is aligned with the mounting flange 182. A known fastener (e.g., a rivet or a screw) may then be inserted through the hooked end 188 and the mounting flange 182 to secure the clip 160 to the extension member 150. Alternatively, the hooked end 188 may be secured to the mounting flange with an interference fit.

The secondary fuse link 152 is coupled to and extends between the clip 190 and the contact pin 154 on opposite ends of the extension member 150. The secondary fuse link 152 is wrapped around the contact pin 154 on en end and electrically connected to the clip 190 at an opposite end. Between the clip 160 and the pin 154, the secondary fuse link 152 is extended along the inner surface 176 of the extension member 150, and the backing layer 158 maintains the secondary fuse link 152 in place and ensures that a portion of the secondary fuse link 152 extends over and adjacent the indicator material 156 in the cavity 178 of the extension member 150.

In further embodiments, an adhesive sealing compound may be employed in the fuse state indicator assembly 102, in particular over the extension member 150 on either side of the cavity 178. For example, a silicon caulk such as a Loctite 5088 compound familiar to those in the art may be used to inhibit possible fulgerite formation around the assembly 102, particularly in the vicinity of the window 124.

FIG. 4 is an exploded assembly view of the fuse 100 including the fuse state indicator assembly 102. The clip 160 and the contact pin 154 extend from opposite ends of the extension member 150 and electrically connect the secondary fuse link 154 (FIG. 3) extending across the extension member 150.

A primary fuse element assembly 200 is electrically connected between the terminal elements 116 and 118 in a known manner. In an illustrative embodiment, the fuse element assembly 200 is a known “class J” fuse element having a short circuit portion 202 and a time delay portion 204, although it is appreciated that other known fuse elements, fusible links, fusible strips and the like may likewise be employed separately or in combination in further and/or alternative embodiments of the invention.

Each of the base portions 120 of the terminal elements 116 and 118 includes an aperture 202 therein, and one of the apertures 202 of the terminal elements 116 and 118 receives the contact pin 154 to mechanically and electrically connect the indicator assembly 102 to the respective terminal element. On the other hand, the strip 190 of the clip 160 extends to the opposite terminal element 116 or 118, and when the fuse 100 is assembled, the strip portion is trapped between the base portion 120 and an interior surface 204 of the body 104. The contact pin 154 anchors a first end of the assembly to the terminal element 116, and when the extension member 150 is fitted within the slot 110 in the fuse body 104, the clip 160 is aligned with the opposite terminal element 118 to make electrical contact therewith. When the primary fuse element 200 is received in a bore 206 through the fuse body 104, the primary fuse element assembly is enclosed within the bore 206, and when the terminal elements 116 and 118 are coupled to the body and the indicator assembly 102 is connected thereto via the contact pin 154 and the clip 160 as described above, the secondary fuse link 154 of the indicator assembly 102 is electrically connected in parallel with the primary fuse element assembly 200 between the terminal elements.

In an illustrative embodiment, apertures 202 are provided in each terminal element 116, and 118 and the apertures 202 are aligned with one another such that the indicator assembly may be installed with the contact pin extending into either of the terminal elements 116 and 118, with the clip 160 engaging the other of the terminal elements 116 and 118. Alternatively, an aperture 202 could be provided in only one of the terminal elements 116, 118 in an embodiment wherein the indicator assembly 102 can be installed in one position only. Additionally, in another embodiment, the extension member 150 could be lengthened and contact pins 154 could be employed at both ends to establish electrical connection of the secondary fuse link 154 to the terminal elements 116, 118.

Once installed, the fuse state indicator assembly 102 functions as follows. When the primary fuse element assembly 200 opens due to an overcurrent condition, the current flows, via the contact pin 154 and the clip 160, through the parallel secondary fuse link 152 of the indicator assembly 102, which causes the secondary fuse link 152 to melt or vaporize. The resultant heat ignites the indicator material 156, and the combustible substance is consumed by confined burning within the recessed cylindrical cavity 178 (FIG. 3) in the extension member 150. When the combustion is complete, the backing layer 158 is visible through the window 124.

Thus, an operative condition or state of the fuse 100 is readily indicated by a visible change of color from, for example, a light color to a dark color, as seen through the window 140. The color visible through the window 240 reflects the respective colors of the indicator material 156 in an unopened or operative condition and the backing layer 158 in an opened or inoperative state after the primary fuse element 200 has opened. That is, to an observer viewing the window 124, when the primary fuse element assembly 200 is operable (i.e., has not melted or opened) the light-colored combustible substance is visible through the window 124. However, when the primary fuse element assembly 200 is inoperable due to melting or opening from a fault current, the current vaporizes the secondary fuse link 154, ignites and consumes the indicator material 156, and thereby reveals the contrasting dark-colored backing layer 158 so that it is visible through the window 124. Reliable local fuse state indication is therefore provided in a low cost assembly 102.

As described below, remote fuse state indication may be provided with such a fuse without hard-wired connections to the fuse 100 and without mechanical actuation features. One such system which may be particularly advantageous with the above-described local fuse state indicator 102 includes an optically activated indicating circuit which senses an emission of light in the indicator 102 when the indicator material 156 is ignited, combusted, and consumed. Once light is sensed when the combustion occurs, the light may be converted into an electrical signal and transmitted to a remote location as described below to alert interested persons of an opened fuse which needs replacement.

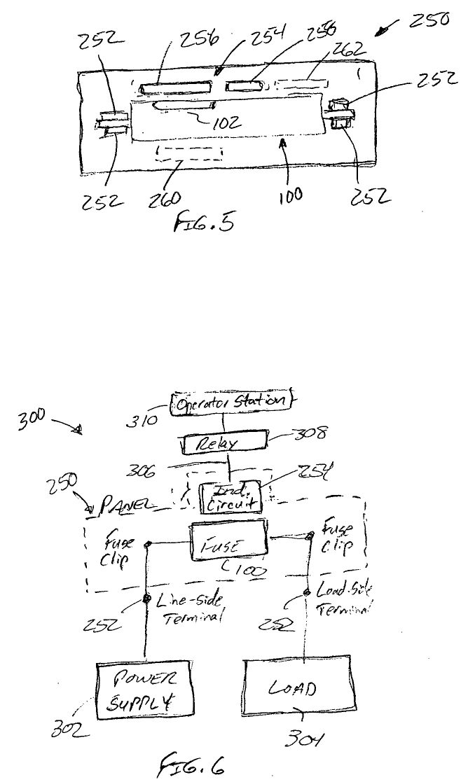

FIG. 5 is top plan view of an exemplary fuse panel, fuse holder, fuse block or fuse panel 250 (collectively referred to herein as “the panel 250”) which may be used, for example, with the fuse 100 shown above in relation to FIGS. 1-4. The panel 250 includes an area dimensioned to accommodate the fuse 100, and conductive terminals 252. In the embodiment of FIG. 2, the terminals 252 are conductive fuse clips known in the art for establishing line and load connections to the fuse 100. Specifically, the clips 252 receive the blades 122 (shown in FIGS. 1 and 2) of the fuse 100. It is contemplated, however, the other types of terminal elements known in the art may be used to establish line-side and load-side electrical connections to electrical circuitry (not shown in FIG. 5). Further, while one fuse 100 is illustrated in the panel 250 in FIG. 5, it is understood that the panel 250 may accommodate more than one fuse 100 to provide fused protection for an electrical system.

In an exemplary embodiment, the panel 250 includes an indicating circuit 254 having a light detecting element 256 and a light emitting element 258 located proximate to but separate from the fuse 100. More specifically, in one embodiment, the light detecting element 256 is light sensitive and is positioned proximate the local fuse state indicator assembly 102 of the fuse 100 such that, when the combustible indicating material 156 (FIG. 3) is ignited, light associated with the ignition and combustion of the indicating material 156 is sensed by the detector element 256. In response to the detecting of light by the element 256, the light detector element 256 activates the light emitting element 258. When activated, the light emitting element 258 transmits an optic signal to a remote location via an optical link (not shown in FIG. 5) to identify the fuse for replacement. The light detecting element 256 in one embodiment is a known photodiode/transistor and the light-emitting device 258 is a known light emitting diode (LED), neon lamp, or other known illuminator which produces light that may be optically transmitted to another location in a relatively low cost manner.

Because the indicating circuit 254 is activated by light, sometimes referred to herein as an optically activated circuit, the circuit 254 may reliably detect operation of the local fuse state indicator assembly 102 over an air interface in the panel 250 while being electrically disassociated from the primary fuse element assembly 200 (FIG. 4). In other words, the indicating circuit 254 is not electrically connected to conductive portions of the fuse 100 or to the primary fuse element assembly 200. Rather, the indicating circuit 254 is responsive to an operating condition or state of the local fuse state indicator assembly 102, and the indicating circuit 254 does not require a direct connection to the primary fuse element 200 to reliably indicate the operative state of the fuse 100. Hard-wired electrical connections to the fuse 100 are therefore avoided, along with the associated installation difficulties and expense of making such connections, and mechanical actuation elements are not needed to activate the indicating circuit 254 when the primary fuse element 200 opens a circuit through the fuse 100. Reliable remote fuse state indication is therefore provided at lower cost than in conventional indication systems.

Alternatively, the panel 250 may include a detecting element 260 (shown in phantom in FIG. 5) which may be used to indirectly detect an operating state of the primary fuse element 200 without a hard-wired connection to the fuse 100. In different embodiments, the detecting element 260 senses current flowing between the fuse terminals 252 in the panel 250, or the detecting element 260 may sense a voltage drop across the terminals 252 when the primary fuse element 200 opens. Current and voltage readings, for example, may be obtained with known sensor elements measured across, for example, a shunt within the fuse 100 or by other techniques known in the art, and when the current and/or voltage readings fall below a predetermined threshold, the circuit 254 activates the light emitting element 258 and transmits an optic signal to a remote location.

In still another alternative embodiment, the detector element 260 is a temperature sensor connected to the fuse terminals 252 of the panel 250. In such an embodiment, the detector element may sense an operating temperature of the fuse terminals 252 to detect opening of the primary fuse element 200 and to activate the light emitting element 258 accordingly when the primary fuse element 200 opens a circuit through the fuse.

By using a detector element 260 in lieu of the light detector element 256, it may be determined whether or not the fuse 100 is operable independently from the local fuse state indicator 102 of the fuse 100. Thus, the detector element 260 allows a lower cost fuse which does not include a local fuse state indicator to be utilized while still achieving reliable remote fuse state indication with an optic signal. It is also contemplated that the light detector element 256 and the detector element 260 may be used in combination if desired for a particular application, and in such an embodiment the light detector element 256 may activate the light emitting element 258 when the local fuse state indicator 102 changes state as described above, and the detector element 260 may activate the light emitting element 258 when sensed current, voltage, or temperatures meet predetermined thresholds which, for example, indicate abnormal or unexpected operating conditions of the fuse 100 in the panel 150. Abnormal or unexpected operating conditions may therefore be identified even when they do not result in opening of the primary fuse element 200 through the fuse 100, which may be of interest to troubleshoot or diagnose problems in an electrical system. Additional light emitting elements 258 may be provided, and the light emitting elements 258 may be selectively illuminated to convey different information to system operators or personnel at a remote location. For example, one light emitting element could be illuminated to indicate an opened fuse, and other light indicating elements 258 may be illuminated to indicate the occurrence of specified current, voltage or temperature conditions.

Still further, an energy storing element 262 (shown in phantom in FIG. 5) may be provided in the indicating circuit 254 to energize and illuminate the light emitting element 258. The energy storage element 262 may be especially useful in certain applications where a loss of voltage when the fuse 100 operates may otherwise cause the light emitting element 258 not to illuminate. For example, in an electric motor application, when the fuse 100 operates a load-side device such as a motor starter, opening of the fuse 100 causes the motor starter to open and create a loss of voltage on the load side terminal 252 which, in turn, may cause the light emitting device to fail to illuminate. The energy storing element 262 may be a capacitor or other known mechanism for storing energy to maintain illumination of the light emitting device 258 in such circumstances.

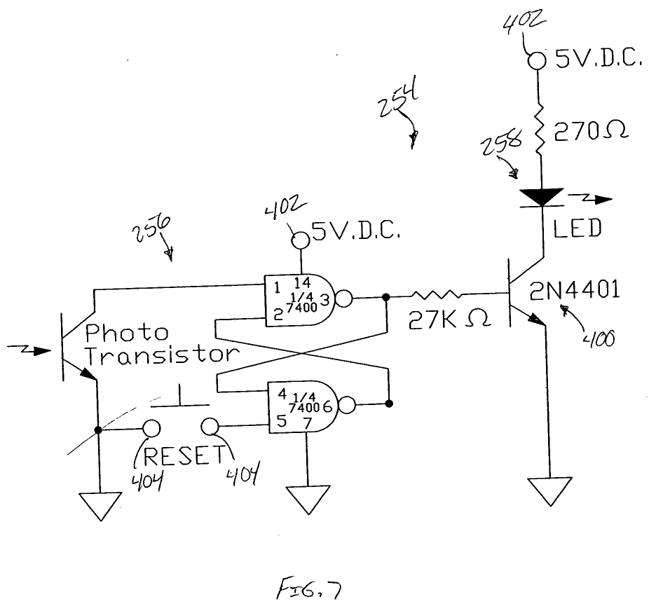

FIG. 6 is a schematic block diagram of a fuse indicating system 300 including the panel 250 interconnected between a power supply or power supply circuitry 302, and an electrical load 304. The fuse 100 is connected to the power supply 302 and to the load 304 via the fuse terminals 252 to complete an electrical connection through the fuse 100 between the power supply 302 and the load 304. In various embodiments, the load 304 may include electrical components (e.g., transformers, inductors, integrated circuits), equipment (e.g., machines, electrical motors and drive components, computers, programmable logic control systems), and sub-circuitry of a larger electrical system. Additionally, the loads 304 may serve as a secondary power source to additional loads (not shown).

As described above, the fuse 100 is constructed to physically break a circuit path and isolate the load 304 from the power supply 302 to prevent damage to the load 304 upon the occurrence of specified current conditions in the circuit, such as specified overcurrent conditions. The indicating circuit 254 is provided in the panel 250 proximate the fuse 100 and is disassociated from the primary fuse element 200 (FIG. 4), and detects operation of the primary fuse element without a hard-wired connection thereto. When the indicating circuit 254 detects an opening of the fuse element by any of the foregoing methods, the circuit 254 illuminates the light emitting device 258 (FIG. 5) to transmit an optic signal via a communications link 116 to a remote location, such as an operator station 310. In one embodiment, the communications link 116 is a high dielectric fiber optic lead or optical cable which is capable of transmitting an optic signal to communicate the fuse status to the remote location. Other known light transmitting mediums may be used for similar purposes in alternative embodiments.

As illustrated in FIG. 6, a switching element such as a relay 308 may be provided in the system 300 so that corrective action may be taken when the fuse 100 opens. For example, the relay 308 may be connected to signal additional devices, such as a motor starter of the opened fuse 100. Thus, for example, when a single fuse in a 3-phase power supply operates, the opened fuse tends to cause an imbalance in the remaining two phases. The signal provided to the relay 308 could allow the 3-phase device such as a motor starter to open, thereby eliminating the imbalance in the circuit and avoiding associated problems until the opened fuse is replaced and all of the 3-phases are restored.

FIG. 7 is an exemplary circuit schematic of an indicating circuit 254 which may be used in the system 300 (FIG. 6). As shown in FIG. 7, the circuit 254 includes a light detecting element 256 in the form of photo transistor connected to a second transistor/diode 400 and a light emitting element 258 in the form of an LED. The circuit 254 is powered by a 5V D.C. power supply 402, and pin 3 of the photo transistor is set low when reset pins 404 of the photo transistor are closed to turn the transistor 400 off so that the LED is not energized and is not lit. When light strikes the photo transistor as the combustible material 156 of the local fuse state indicator 102 is ignited and consumed, pin 3 of the photo transistor is latched to turn on the transistor 400 and energize the LED. Light from the LED is transmitted to a remote location as an optic signal via the communications link 306 (FIG. 6) for remote fuse state indication. As noted above, the circuit 254 may also include energy storage elements 260 (FIG. 5), more than one light emitting element 258 and other modifications as desired or as necessary to achieve particular objectives in use.

While the invention has been described in terms of various specific embodiments, those skilled in the art will recognize that the invention can be practiced with modification within the spirit and scope of the claims.

What is claimed is:

1. A fuse state indicating system comprising:
at least one fuse comprising a primary fuse element; and
an indicating circuit proximate said fuse and disassociated from said primary fuse element, said indicating circuit configured to detect an opening of said primary fuse element wherein a circuit path is broken through said primary fuse element, said circuit further configured to transmit an optic signal to a remote location when said opening of said primary fuse element is detected, said signal being transmitted without mechanical actuation of said circuit.

2. A fuse state indicating system in accordance with claim 1, said fuse comprising a combustible fuse state indicator, and said indicating circuit being activated by combustion of said indicator to transmit said optic signal.

3. A fuse state indicating system in accordance with claim 1 wherein said circuit comprises a light detecting element.

4. A fuse state indicating system in accordance with claim 1 wherein said circuit comprises a light detecting element and a light emitting element, said light detecting element activated by an emission of light contemporaneous with said opening of said primary fuse element and causing said light emitting element to transmit said optical signal.

5. A fuse state indicating system in accordance with claim 1, wherein said circuit comprises a light emitting element activated in response to said opening of said primary fuse element, and an optical link proximate said light emitting element.

6. A fuse state indicating system in accordance with claim 1 wherein said circuit includes at least one of a voltage monitoring element and a current monitoring element.

7. A fuse state indicating system in accordance with claim 1 further comprising a fuse panel, said circuit mounted to said fuse panel to detect said opening of said primary fuse element.

8. A fuse state indicating system in accordance with claim 7, said fuse panel comprising line and load terminals, said circuit configured to detect a voltage or current condition of said line and load terminals.

9. A fuse state indicating system in accordance with claim 1 wherein said circuit further comprises a switching element, said switching element responsive to said optic signal.

10. A fuse state indicating system in accordance with claim 1 wherein said circuit further comprises an energy storage element and a light emitting element, said energy storage element illuminating said light emitting element when said primary fuse element opens.

11. A fuse indicating system comprising:
a fuse having a primary fuse element and a local fuse state indicator, said local fuse state indicator responsive to an operating condition of said primary fuse element and visually indicating said operating condition of said primary fuse element without utilizing a mechanical indicating element; and
an indicating circuit responsive to a state of said local fuse state indicator, said indicating circuit configured to send an optic signal to a remote location when said local fuse state indicator indicates that said primary fuse element is inoperable.

12. A fuse state indicating system in accordance with claim 11 wherein said local fuse state indicator comprises a combustible fuse material, and said indicating circuit being activated by combustion of said combustible material to transmit said optic signal.

13. A fuse state indicating system in accordance with claim 11 wherein said circuit comprises a light detecting element positioned proximate to but separate from said fuse.

14. A fuse state indicating system in accordance with claim 11 wherein said light detecting element comprises a light detecting element and a light emitting element, said light detecting element activated by an emission of light generated in said local fuse state indicator and causing said light emitting element to transmit said optic signal.

15. A fuse state indicating system in accordance with claim 11, wherein said circuit comprises a light emitting element activated in response to a change of state of said local fuse state indicator.

16. A fuse state indicating system in accordance with claim 11 wherein said circuit further comprises a switching element, said switching element responsive to said optic signal.

17. A fuse state indicating system in accordance with claim 11 wherein said circuit further comprises an energy storage element and a light emitting element, said energy storage element illuminating said light emitting element in response to a condition of said local fuse state indicator.

18. A fuse state indicating system comprising:
at least one fuse comprising a primary fuse element; and
an optically activated indicating circuit proximate said fuse and disassociated from said primary fuse element, said circuit comprising a light detecting element configured to detect an opening of said primary fuse element and a light emitting element configured to transmit an optic signal to a remote location.

19. A fuse state indicating system in accordance with claim 18 wherein said fuse comprises a combustible fuse state indicator, said light detecting element activated by combustion of said combustible fuse state indicator to energize said light emitting element.

20. A fuse state indication system comprising:
a fuse having a primary fuse element and a combustible fuse state indicator for local fuse state indication;
means for detecting combustion of said combustible fuse state indicator; and
means for transmitting a signal to a remote location, responsive to said means for detecting, when said combustion occurs.

21. A fuse state indication system in accordance with claim 20 wherein said means for detecting comprises a light sensitive detector element.

22. A fuse state indication system in accordance with claim 20 wherein said means for transmitting comprises a light emitting element and an optical link.

23. A fuse state indicator in accordance with claim 20 wherein said fuse is a cylindrical cartridge fuse.
